(19) United States
(12) Patent Application Publication
(10) Pub. No.: US 2011/0208606 A1
(43) Pub. Date: Aug. 25, 2011

(54) Information Technology Services E-Commerce Arena for Cloud Computing Environments

(75) Inventors: Ethan Hadar, Nesher (IL); Ajei Gopal, Riverdale, NY (US)

(73) Assignee: Computer Associates Think, Inc., Islandia, NY (US)

(21) Appl. No.: 12/708,879

(22) Filed: Feb. 19, 2010

(51) Int. Cl. G06Q 30/00; G06Q 10/00; G06Q 50/00

(52) U.S. Cl. 705/26.2; 705/14.23

(57) ABSTRACT

A system and method for IT services e-commerce arena for cloud computing environments is disclosed. The method includes receiving, from each of a plurality of service clients, a request for processing time on a processor. The method also includes receiving, from each of a plurality of service providers, an offer for processing time on a processor operated by each respective service provider. Additionally, the method includes generating a buyer group based on information included in each respective request, wherein the buyer group comprises a selected one or more of the plurality of service clients to receive processing time on a processing resource and selecting one of the plurality of service providers to provide processing time on the processor operated by the selected service provider to the service clients in the buyer group. Further, the method includes initiating a transaction between each of the service clients in the buyer group and the selected service provider.

### TECHNICAL FIELD OF THE INVENTION

This disclosure relates generally to information technology commerce, and more particularly to an information technology services e-commerce arena for cloud computing environments.

### BACKGROUND

In the cloud computing domain, and specifically in the Infrastructure as a Service and Software as a Service domains, information technology organizations can offload information technology capabilities (from the organization datacenter) to the public clouds. They may also use an outsourcing agency to handle problem issues and provide service desk solutions. For particular information technology services, smaller consumers may have difficulties contracting with larger enterprises. At the same time, larger enterprises may have difficulty reaching smaller consumers.

### SUMMARY

In accordance with the present invention, the disadvantages and problems associated with information technology brokerage systems have been substantially reduced or eliminated.

In accordance with one embodiment of the present disclosure, a method includes receiving, from each of a plurality of service clients, a request for processing time on a processor. The method also includes receiving, from each of a plurality of service providers, an offer for processing time on a processor operated by each respective service provider. Additionally, the method includes generating a buyer group based on information included in each respective request, wherein the buyer group comprises a selected one or more of the plurality of service clients to receive processing time on a processing resource and selecting one of the plurality of service providers to provide processing time on the processor operated by the selected service provider to the service clients in the buyer group. Further, the method includes initiating a transaction between each of the service clients in the buyer group and the selected service provider.

In accordance with another embodiment of the present disclosure, a system includes a plurality of service clients each operable to transmit a request for processing time on a processor. The system also includes a plurality of service providers each operable to transmit an offer for processing time on a processor operated by each respective service provider. Further, the system includes a brokerage server. The brokerage server is operable to receive, from each of the plurality of service clients, the request and receive, from each of the plurality of service providers, the offer. The brokerage server is further operable to generate a buyer group based on information included in each respective request, wherein the buyer group comprises a selected one or more of the plurality of service clients to receive processing time on a processing resource. The brokerage server is additionally operable to select one of the plurality of service providers to provide processing time on the processor operated by the selected service provider to the service clients in the buyer group and initiate a transaction between each of the service clients in the buyer group and the selected service provider.

In accordance with yet another embodiment of the present disclosure, a computer readable storage medium comprises logic, and the logic is operable, when executed, to receive, from each of a plurality of service clients, a request for processing time on a processor and receive, from each of a plurality of service providers, an offer for processing time on a processor operated by each respective service provider. The logic is further operable to generate a buyer group based on information included in each respective request, wherein the buyer group comprises a selected one or more of the plurality of service clients to receive processing time on a processing resource. Additionally, the logic is operable to select one of the plurality of service providers to provide processing time on the processor operated by the selected service provider to the service clients in the buyer group and initiate a transaction between each of the service clients in the buyer group and the selected service provider.

Technical advantages of certain aspects of the present invention include providing for efficient capacity management of information technology service provided by service providers. Aspects of embodiments of the present disclosure allow service providers to achieve maximum possible utility computing resources and increase sales to opportunistic service clients. Additionally, small and midsize companies may consume services of larger organizations and larger enterprises. Small providers of service may provide services to larger enterprise organizations and may be charged for actual services provided according to qualitative service measurements. Embodiments of the present disclosure provide for metering and evaluation of the value provided by service providers according to quality of service metrics, and may bill service clients accordingly. Particular embodiments provide the ability to validate the quality of the provided services, and provide for payment for actual consumption assuming the quality was not impaired. While individual medium and small sized companies find it difficult to negotiate these conditions, a brokerage server can provide this service, and add additional business packages to reduce the cost for opportunistic consumers, as well as maximize utilizations for service providers. Additionally, particular embodiments of the present disclosure enable service clients to automate requests for proposals and delegate the procurement of information technology business to external entities. By grouping service clients together, particular embodiments foster the construction of ad-hoc transient communities that may generate demand and search for the best supply offered in an information technology network cloud. Particular embodiments of the present disclosure may also reduce the complexity of managing multiple consumers, while increasing the revenue of a single machine for service providers, which may lower prices for the service clients by constructing time-sharing and obtaining volume discounts through the brokering services. Additionally, e-commerce arenas maximize existing resources by balancing supply and demand of available services. It facilitates an electronic environment that offers either group purchases, just-in-time utilization for a limited period, or long time commitment, by adding known economical trading capabilities into the offerings. The service brokering facilitates e-commerce for the domain of information technology services.

Other technical advantages of the present disclosure will be readily apparent to one skilled in the art from the following figures, description, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description taken in conjunction with the accompanying drawings, in which:

FIG. 1 illustrates a brokerage system in accordance with particular embodiments of the present disclosure, including a brokerage server, service clients, service providers, and a network;

FIG. 2 illustrates the brokerage server illustrated in FIG. 1 in more detail, including aspects of the present disclosure; and

FIG. 3 is a flow chart illustrating a particular operation of the brokerage system of FIG. 1 in accordance with particular embodiments of the present disclosure.

### DETAILED DESCRIPTION

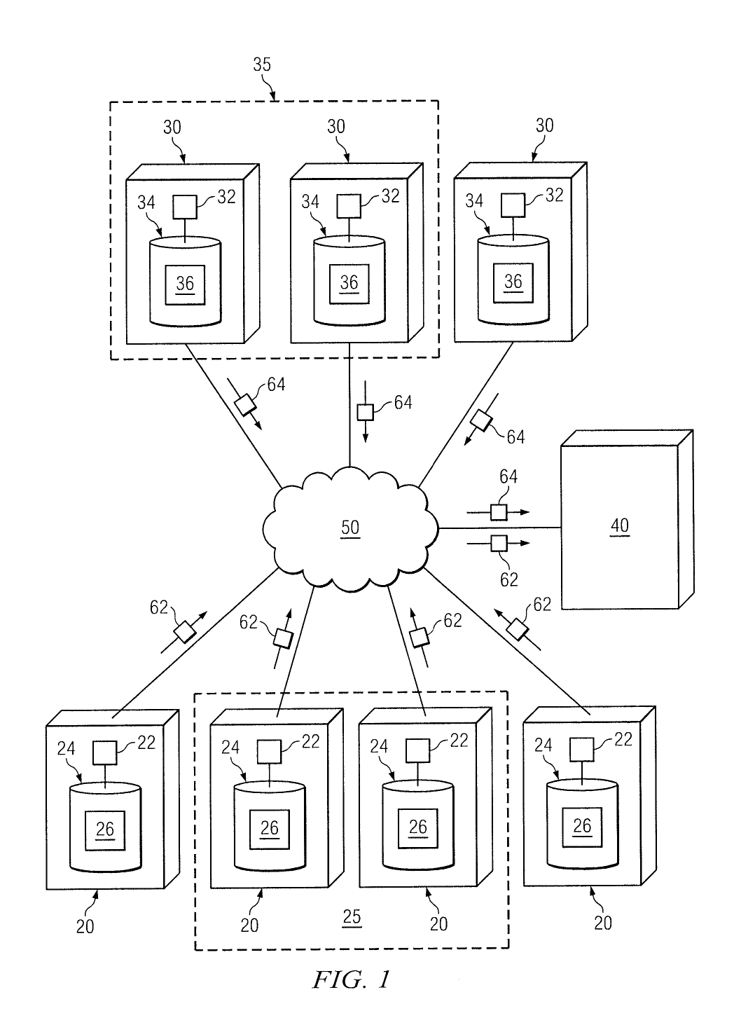

FIG. 1 illustrates an information technology brokerage system 10, according to certain embodiments. Brokerage system 10 includes one or more service clients 20, one or more service providers 30, and brokerage server 40. Service clients 20, service providers 30, and brokerage server 40 may be communicatively coupled by network 50. Brokerage system 10 is generally operable to facilitate transactions associated with information technology services between service clients 20 and service providers 30. To facilitate transactions, brokerage server 40 receives request data 62 that includes a request for information technology services from service clients 20 and offer data 64 that identifies information technology services offered by service providers 30. Using information included in received request data 62 and received offer data 64, brokerage server 40 selects one or more service clients 20 to receive an information technology service and selects one or more service providers 30 to provide the information technology service.

For purposes of this description, an information technology service refers to any service associated with computing resources, computer memory, computing processing power, computer storage, computer applications, or any other processing or exchange of electronic data. For example, in particular embodiments, an information technology service represents a service providing for storage of electronic or computer data. In this example information technology service, service providers 30 may sell computer storage space of varying amounts to one or more clients 20. As another example, an information technology service may represent a software application operating over a network. In this example information technology service, service providers 30 operate a software application over a computer network and sell access to the software application for limited or unlimited amounts of time to service clients 20. Thus, service clients 20 may purchase discrete amounts of time during which service clients 20 are allowed to access and use the software application provided by a particular service provider 30. As another example, an information technology service represents a service allowing for access to processing power over a computer network. In this example information technology service, service providers 30 operate and sell access to processors over a computer network. Service clients 20 may purchase processing time on the processors, during which service clients 20 execute their own software application for a limited or unlimited period of time.

Using request data 62 received from service clients 20 and offer data 64 for service received from service providers 30, brokerage server 40 initiates transactions between service clients 20 and service providers 30. Brokerage server 40 may initiate transactions between service clients 20 and service providers 30 in several ways. In one embodiment, brokerage server 40 matches service client 20 that requests a particular information technology service with service provider 30 that offers the particular information technology service. Brokerage server 40 initiates the transaction by notifying service client 20 that service provider 30 is offering the requested information technology service, and by notifying service provider 30 that service client 20 is requesting the offered information technology service. Service clients 20 and service provider 30 may transmit an acknowledgement to brokerage server 40 and/or to the other party.

In some embodiments, brokerage server 40 initiates transactions that include enhanced service offerings. For example, service providers 30 may offer an information technology service as a last minute offer. A last minute offer of information technology service from service provider 30 includes a shortened offer expiration period. In exchange for the shortened offer expiration period, service provider 30 discounts the price of the information technology service from a price at which service provider 30 would sell the information technology service absent the shortened expiration period. In some embodiments, brokerage server 40 notifies service clients 20 of a last minute offer. Clients 20 may choose to accept or decline the last minute offer of information technology service. In this way, brokerage server 40 allows service clients 20 to take advantage of discounted last minute offers offered by service providers 30, and allows service providers 30 to efficiently maximize information technology service capacity.

As another example, in response to request data 62 received from service client 20 received by brokerage server 40, service provider 30 transmits offer data 64 which includes an offer to defer fulfillment of the requested service in exchange for a discounted price. Brokerage server 40 receives request data 62 from service client 20 requesting an information technology service and determines which service providers 30 have offered the information technology service to brokerage server 40. Brokerage server 40 notifies service providers 30 offering the requested information technology service that service client 20 has requested the information technology service. In response, a particular service provider 30 may respond with offer data 64 that offers to defer provisioning of the information technology service in exchange for a price that is discounted from a price the service provider 30 would charge for immediate fulfillment of the information technology service. Brokerage server 40 notifies service client 20 of the offer to defer provisioning, and service client 20 may accept the offer of deferred provisioning, or may choose immediate fulfillment of the requested information technology service from service provider 30.

As yet another example, brokerage server 40 groups one or more request data 62 for the same information technology service into a bundled service request. Brokerage server 40 may form buyer group 25 comprising service clients 20 that have requested a same or similar information technology service. Brokerage server 40 transmits the bundled service request to service providers 30 that are offering the requested information technology service. In this way, buyer group 25 represents a virtual service client 20 that requests an information technology service from a particular service provider 30. In exchange for the greater volume of requested information technology service, a particular service provider 30 may offer the requested information technology service at a reduced price. Conversely, a particular service provider 30 may transmit to brokerage server 40 offer data 64 that includes an offer of a discounted price for a particular volume of information technology service. In response, brokerage server 40 selects a number of service clients 20 that request the offered service, and which collectively meet the particular volume requirements of service provider 30. Service provider 30 then provides the information technology service 30 to a group of participating service clients 20 at a price discounted from the sum of the prices it would charge each participating service client 20 if the service were provided on an individual basis. In this manner, brokerage server 40 achieves a volume discount for each participating service client 20, without necessitating coordination among participating service clients 20.

As an illustration, a particular service provider 30 may offer data storage over a computer network in 50 megabyte and 100 megabyte increments. The price for a 100 megabyte increment is discounted from the price of two 50 megabyte increments. One particular service client 20 requests 50 megabytes of storage, another particular service client 20 requests 25 megabytes of data storage, and another particular service client 20 requests 25 megabytes of data storage. Brokerage server 40 groups the three service clients 20 into buyer group 25, and notifies the offering service provider 30 that buyer group 25 is willing to purchase its offered service. Service provider 30 provides 100 megabytes of data storage to the three requesting service clients 20 at a price discounted from the price of purchasing two 50 megabyte increments. As a result, the three requesting service clients 20 obtain a price for data storage discounted from a price they would otherwise be able to obtain, without having to coordinate among themselves. Service clients 20 may pay according to a minimum price set by the particular service provider 30 and/or brokerage server 40, and/or the amount of data storage actually consumed. Similar volume discounts may be obtained for other information technology services, including, but not limited to, software applications executing over a computer network, and processing time offered over a computer network.

As yet another example, brokerage server 40 receives request data 62 for information technology service from service client 20 that includes a proposal for the requested information technology service. The proposal may include one or more service terms, such as, for example, a service level agreement, a type of requested service, a processing time required, a price level, and a time at which the proposal expires. Additionally or alternatively, the proposal may include requests for different information technology services to be fulfilled by one or more different service providers 30. For example, the request may include a request for data storage and web hosting service. Brokerage server 40 may notify one or more service providers 30 of the request for information technology services. Service providers 30 may accept the request for service, reject the request for service, or transmit a response to brokerage server 40 that includes a counteroffer for the requested information technology service. The counteroffer may include altered service terms, a different price for the requested service and/or any other terms at which service provider 30 is able to provide the requested information technology service. A particular service provider 30 may select one or more of the requested information technology services to provide. For example, a particular service provider 30 may provide data storage, but not web hosting services. Brokerage server 40 notifies service client 20 when one or more service providers 30 have accepted the requests for information technology services. In this manner, brokerage server 40 facilitates requests for proposals from service providers 30 for one or more information technology services. Thus, service client 20 is able to obtain an integrated solution without having to request services from multiple service providers 30.

Once an information technology service transaction is initiated between one or more service clients 20 and one or more service providers 30, brokerage server 40, in some embodiments, monitors service level agreements associated with the fulfillment of the information technology service to provide billing, metering, usage monitoring, and/or any other appropriate quality assurance to service client 20 and/or service provider 30. As an illustration, service client 20 may purchase a web hosting service from service provider 30 that includes a limitation on the amount of data transferred per month. Brokerage server 40 monitors the amount of data transferred, and if the web server transfers more than the monthly limit, brokerage server 40 may take remedial action, including terminating the information technology service, directly billing service client 20 for the overage, or notifying service provider 30 that the monthly limit has been exceeded, so that it may generate a bill for the overage amount. Further, if service provider 30 experiences an outage of the information technology service at any time during the service period, brokerage server 40 may refund a portion of the price paid by service client 20 for the time during which service was unavailable and/or for the entire amount paid. In some embodiments, service client 20 may pay on a per-usage basis. For example, service client 20 may pay for an amount of information technology service actually consumed over a predetermined period of time. In such embodiments, brokerage server 40 monitors the amount of information technology service that service client 20 consumes, and generates a bill for the consumption at an appropriate time.

Service client 20 transmits request data 62 for an information technology service to brokerage server 40. Request data 62 may include, for example, a type of requested service, a processing time required, a service level agreement, a price service client 20 is offering to pay, and a time at which the request expires. However, it should be understood that request data 62 may include any appropriate information suitable to request an information technology service from brokerage server 40 and/or service provider 30 and transact with service provider 30. Service client 20 also receives confirmation from brokerage server 40 that a particular service provider 30 is providing the request information technology service. In particular embodiments, a plurality of service clients 20 may be grouped into buyer group 25 for facilitating time-sharing of information technology service, group purchases, and/or volume discounts. Once an information technology service is procured from service provider 30, service client 20 may interact with or more other components associated with service provider 30 to receive the information technology service. In particular embodiments service client 20 represents one or more components that separately request and/or utilize an information technology service provided by service provider 30. In particular embodiments, request data 62 may include a request for proposal (RFP). An RFP specifies particular types and qualities of one or more information technology services. For example, a particular RFP may specify that service client 20 is requesting web hosting service, data storage, and web applications. The particular RFP may also include characteristics of the requested types of information technology services, such as, for example, an amount of data storage, an amount of megabytes the web hosting service should transfer over a predetermined time period, and an amount of processing power web applications should receive. The particular RFP may also specify a price service client 20 is willing to pay for the requested information technology services. Service client 20 may comprise memory 22 and processor 24.

Memory 22 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 22 as internal to service client 20, it should be understood that memory 22 may be internal or external to service client 20, depending on particular implementations. Memory 22 may be separate from or integral to other memory devices to achieve any suitable arrangement of memory devices for use in brokerage system 10.

Memory 22 stores request data 62, a list of procured information technology services, an amount paid for each of the information technology services, and/or any other information associated with the request, procurement, reception, and/or use of information technology services. Memory 22 also stores logic 26. Logic 26 generally comprises rules, algorithms, code, tables, and/or other suitable instructions for storing and/or generating request data 62, and responding to offer data 64 for information technology services from service provider 30.

Memory 22 is communicatively coupled to processor 24. Processor 24 is generally operable to execute logic 26 to perform the functionality provided by service clients 20. Processor 24 comprises any suitable combination of hardware and software implemented in one or more modules to provide the described function or operation.

Service provider 30 provides information technology services to service clients 20. Service providers 30 use brokerage server 40 to facilitate a transaction with one or more service clients 20. For example, service provider 30 receives request data 62 which identifies information technology service requested by service clients 20 from brokerage server 40 and transmits offer data 64 for information technology services to brokerage server 40. Service provider 30 may provide one or more information technology services. For example, service provider 30 may provide internet website hosting, data storage, internet application hosting, software as a service hosting, and/or application processing. It should be understood, however, that service provider 30 may provide any information technology service associated with the processing, transfer, generating and/or exchange of data.

As discussed above, service provider 30 may utilize brokerage server 40 to provide enhanced service offerings associated with the provision of information technology services. For example, offer data 64 may include a last minute offer of information technology service. Brokerage server 40 may notify particular service clients 20 that request the particular information technology service that service provider 30 is offering a last minute deal. Service provider 30 may also offer discounts to service client 20 for deferring services requested by service client 20. In some embodiments, service provider 30 offers discounts to service clients 20 for grouping requests into a larger-volume transaction. It should be understood, however, that service provider 30 may offer any appropriate enhanced service offerings associated with the provision of information technology services.

In particular embodiments, service provider 30 represents a computer that is capable of interacting with brokerage server 40 to offer an information technology service to one or more service clients 20 and capable of providing the information technology service to service client 20. In other embodiments, service provider 30 represents one or more computers that collectively perform the described functions. For example, a particular component of service provider 30 interacts with brokerage server 40 to offer information technology services to service clients 20, and a separate component of service provider 30 communicates and/or interacts with service clients 20 to provide the information technology service to service clients 20.

Service provider 30 comprises memory 32 and processor 34. Memory 32 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 1 illustrates memory 32 as internal to service provider 30, it should be understood that memory 32 may be internal or external to service provider 30, depending on particular implementations. Memory 32 may be separate from or integral to other memory devices to achieve any suitable arrangement of memory devices for use in brokerage system 10.

Memory 32 stores offer data 64, a list of service clients 20 receiving information technology services from service provider 30, an amount paid for each of the information technology services, and/or any other information associated with the offer, procurement, provisioning, and/or use of information technology services. Memory 32 also stores logic 36. Logic 36 generally comprises rules, algorithms, code, tables, and/or other suitable instructions for offering and/or providing information technology services.

Memory 32 is communicatively coupled to processor 34. Processor 34 is generally operable to execute logic 36 to perform the functionality provided by service provider 30. Processor 34 comprises any suitable combination of hardware and software implemented in one or more modules to provide the described function or operation.

Brokerage server 40 facilitates transactions between service clients 20 and service providers 30. Brokerage server 40 receives request data 62 from service clients 20 and receives offer data 64 for information technology service from service providers 30. In particular embodiments, brokerage server 40 may match willing buyers and sellers of information technology services. In some embodiments, brokerage server 40 may select a plurality of service clients 20 requesting a same or similar information technology service and form buyer group 25 from the selected plurality of service clients 20. By grouping multiple clients 20 into buyer group 25, brokerage server 40 is capable of obtaining numerous benefits for service clients 20 included in buyer group 25 including, but not limited to, volume discounts, time-sharing of processor utilization, and/or space-sharing of data storage. In some embodiments, brokerage server 40 generates buyer group 25, and presents buyer group 25 as a single virtual service client 20 to service providers 30. Thus, from the perspective of a particular service provider 30, service provider 30 is transacting with a single service client 20, thus reducing transaction costs associated with the provisioning of an information technology service.

In some embodiments, brokerage server 40 generates seller group 35 comprising one or more service providers 30, and presents seller group 35 as a single virtual service provider 30 to service clients 20. For example, in some embodiments, a particular service client 20 may transmit request data 62 that includes an RFP. The RFP may include a request for proposal that includes a request for more than one information technology service. Brokerage server 40 may determine which service providers 30 offer one or more of the requested information technology services, select the service providers 30 to provide the information technology services, and group the selected service providers 30 into seller group 35. Thus, while separate service providers 30 are providing different information technology services, from the perspective of the requesting service client 20, the information technology services are provided by a single virtual service provider 30.

In some embodiments, brokerage server 40 facilitates an auction for information technology services provided by service providers 30. For example, service providers 30 may transmit offer data 64 that includes an offer to bid on an information technology service. Brokerage server 40 may notify service clients 20 of the offer to bid on an information technology service. Service clients 20 may participate in an auction by transmitting bids over network 50 to brokerage server 40. Once a winning bid is established, brokerage server 40 may initiate a transaction between the winning service client 20 and an offering service provider 30. As another example, service clients 20 may transmit request data 62 that includes a request for an auction in which service providers 30 bid on providing an information technology service. Brokerage server 40 notifies service providers 30 of the request for an auction and the requested information technology service. Service providers 30 then transmit bids to brokerage server 40. Brokerage server 40 selects a winning bid, and notifies the requesting service client 20. Brokerage server 40 then initiates a transaction between the requesting service client 20 and the winning service provider 30.

Brokerage server 40, in particular embodiments, monitors a quality of service associated with the information technology service provided to service client 20 to provide billing, metering, usage monitoring, service level agreement monitoring and/or any other appropriate quality assurance to service client 20 and/or service provider 30. Based on the monitoring, brokerage server 40 may generate a bill to service client 20, adjust a price to be paid for an information technology service, and/or issue a refund for a paid-for information technology service.

Each of service client 20, service provider 30, and brokerage server 40 comprises any suitable combination of hardware and/or software implemented in one or more modules to provide the described functions and operations. In some embodiments, service client 20, service provider 30, and/or brokerage server 40 may comprise a general-purpose personal computer (PC), a Macintosh, a workstation, a Unix-based computer, a server computer, or any suitable processing device. In some embodiments, the functions and operations described above may be performed by a pool of multiple service clients 20, service providers 30, and/or brokerage servers 40. Service clients 20, service providers 30, and brokerage server 40 are communicatively coupled via one or more networks 50. Network 50 may represent any number and combination of wireline and/or wireless networks suitable for data transmission. Network 50 may, for example, communicate internet protocol packets, frame relay frames, asynchronous transfer mode cells, and/or other suitable information between network addresses. Network 50 may include one or more intranets, local area networks, metropolitan area networks, wide area networks, cellular networks, all or a portion of the Internet, and/or any other communication system or systems at one or more locations.

In operation, brokerage server 40 receives request data 62 from service clients 20 and offer data 64 from service providers 30, and facilitates transactions for information technology services between one or more service clients 20 and one or more service providers 30. Brokerage server 40 receives request data 62 from service clients 20. Request data 62 includes a request for an information technology service. For example, request data 62 may include a request for data storage, access to software as a service operated by service provider 30, access to internet-based applications hosted by service provider 30, access to computing time on a processor operated by service provider 30, internet website hosting, and/or any other appropriate information technology service associated with the processing, transfer, generating and/or exchange of data. In some embodiments, brokerage server 40 receives request data 62 over network 50. Additionally, brokerage server 40 may receive a plurality of request data 62 from a particular service client 20 and/or a plurality of service clients 20.

Brokerage server also receives offer data 64 from service provider 30, which includes an offer for one or more information technology services. As noted above, an offer for information technology services may include an offer for data storage, access to software as a service operated by service provider 30, access to internet-based applications hosted by service provider 30, access to computing time on a processor operated by service provider 30, internet website hosting, and/or any other appropriate information technology service associated with the processing, transfer, generating and/or exchange of data. Brokerage server 40 may receive offer data 64 an information technology service from service provider 30 over network 50.

At appropriate times during operation, brokerage server 40 determines whether request data 62 received from of a plurality of service clients 20 includes requests for a same or similar processing resource. Brokerage server 40 uses information included in each of the particular request data 62, such as, for example, the type of processing resource requested, a processing time required, a service level agreement requested by service client 20, a price service client 20 is offering to pay, and a time at which the request expires, to match same or similar requests. For example, requests from service clients 20 requesting data storage may be identified as the same or similar. Sub-groups may be formed for service clients 20 requesting request data storage of an equal amount. As another example, brokerage server 40 may determine that request data 62 from service clients 20 that requests internet website hosting are the same or similar. The amount of variance that may exists between the one or more requests that brokerage server 40 considers the same or similar may vary depending on the overall capabilities and requirements of brokerage system 10.

Based on a determination that request data 62 received from multiple service clients 20 includes request for the same or similar information technology service, brokerage server 40 generates buyer group 25. Buyer group 25 comprises service clients 20 that request the same or similar information technology service. The formation of buyer group 25 for obtaining information technology service from service providers 30 facilitates time-sharing of information technology service, group purchases, and/or volume discounts.

In particular embodiments, brokerage server 40 forms seller group 35. Seller group 35 comprises one or more service providers 30, and presents seller group 35 as a single virtual service provider 30 to service clients 20. For example, in some embodiments, a particular service client 20 may transmit request data 62 that includes an RFP. The RFP may include a request for proposal that includes a request for more than one information technology service. Based on request data 62, brokerage server 40 may determine which service providers 30 offer one or more of the requested information technology services, select service providers 30 to provide the information technology services, and group the selected service providers 30 into seller group 35. In some embodiments, brokerage server 40 may facilitate transactions between buyer group 25 and seller group 35. Thus, a plurality of service providers 30 may be providing information technology services to multiple service clients 20, while appearing as a transaction between a single service client 20 and service provider 30 from the perspective of each particular service client 20 and service provider 30.

Once request data 62 and offer data 64 is received, brokerage server 40 may facilitate transactions between service clients 20 requesting a particular information technology service and service providers 30 providing the particular information technology service. Brokerage server 40 selects one of the plurality of service providers 30 and/or seller group 35 to provide to information technology service to a particular service client 20 and/or service clients 20 in buyer group 25. Brokerage server 40 selects service provider 30 and/or seller group 35 to provide the information technology service based on any appropriate criteria, factors, or variables. For example, brokerage server 40 may select a particular service provider 30 that is offering the lowest price for the requested service. Brokerage server 40 may select a particular service provider 30 that is offering the soonest execution time, most favorable service level agreements to service clients 20. Brokerage server 40 may select a particular service provider 30 that is offering a last minute deal, offering to defer access to the processor in exchange for a discount, and/or offering a discount for volume purchases by multiple service clients 20. In general, however, brokerage server 40 may select a service provider 30 based on a combination of any appropriate criteria, factors, or variables.

Once a particular service client 20 and service provider 30 are selected, brokerage server 40 initiates a transaction between service client 20 and service provider 30. In particular embodiments, brokerage server 40 initiates a transaction between buyer group 25 and service provider 30 and/or service client 20 and seller group 35, and/or any combination thereof. Brokerage server 40 may initiate a transaction by transmitting a notification to service provider 30 that service client 20 has requested its offered service and by transmitting a notification to the service client 20 that service provider 30 has offered its requested service. In particular embodiments, service client 20 and service provider 30 may transmit to brokerage server 40 an acknowledgement that that service client 20 and/or service provider 30 will accept the transaction. The receipt of acknowledgement may finalize the transaction. Brokerage server 40 may accept payment for the requested information technology service from service clients 20, or service clients 20 may pay the relevant service provider 30 directly.

Once a transaction is initiated, brokerage server 40 may monitor the provisioning of the access to the processor of service provider 30 to ensure adequate quality assurance for service client 20 and to adjust a price paid for access to the process in cases of inadequate quality assurance. Brokerage server 40 may provide metering of services consumed, monitor the quality of services provided and/or provide any other quality assurance for service clients 20 and/or service provider 30. For violations of service level agreements, brokerage server 40 may take remedial action, including terminating the information technology service, billing service client 20 for any overages, or providing a refund to service clients 20 for any impairments of quality in the information technology service. In some embodiments, service client 20 may pay on a per-usage basis. For example, service client 20 may pay for an amount of information technology service actually consumed over a predetermined period of time. In such embodiments, brokerage server 40 monitors the amount of information technology service that service client 20 consumes, and generates a bill for the consumption at an appropriate time.

By initiating transactions between service clients 20 and service providers 30, and monitoring the quality of provisioned information technology services, brokerage system 10 provides numerous operational benefits. For example, operational benefits include providing for efficient capacity management of information technology services provided by service providers 30. Additionally, brokerage system 10 allows service providers 30 to achieve maximum possible utilization of computing resources and increase sales to opportunistic service clients 20. Small and midsize companies may consume services of larger organizations and larger enterprises. Small service providers 30 may provide services to larger enterprise organizations and may be charged for actual services provided according to qualitative service measurements. Additionally, brokerage system 10 provides for metering and evaluation of the value provided by service providers 30 according to quality of service metrics, and may bill service clients 20 accordingly. Brokerage system 10 enables service clients 20 to automate requests for proposals and delegate the procurement of information technology business to external entities. By grouping service clients 20 together, brokerage system 10 particular embodiments fosters the construction of ad-hoc transient communities that may generate demand and search for the best supply offered in an information technology network cloud. Brokerage system 10 may also reduce the complexity of managing multiple consumers, while increasing the revenue of a single machine for service providers 30, which may lower prices for the service clients 20 by constructing time-sharing and obtaining volume discounts through the brokering services. Additionally, brokerage system 10 provides the ability to monitor the quality of the provided services. In particular embodiments, the fulfillment of the payment is based on actual measured and approved quality of the requirements. In some embodiments, the ability to form aggregated grouping discounts that are not based on equal participation, rather on quota accumulation. Brokerage system 10 may also provide the ability to provision different needs of different users, on the same provider machines, thus managing the information technology concerns of the opportunistic users and multiple solutions (deployment, monitoring, identity provisioning, etc). Brokerage system 10 may also provide the ability to provide ad-hoc real-time collaboration and establishment of resources, aimed at maximizing the commodity utilization, that otherwise is lost (e.g., advanced last minute offerings). Additionally particular embodiments of brokerage system 10 enable medium and small companies to provide services to larger enterprise organizations by fostering joint collaborations, and vice versa, to large organization leverage on small organization's solutions.

As a result, brokerage system 10 may provide numerous operational benefits. Nonetheless, particular embodiments may provide some, none, or all of these operational benefits, and may provide additional operational benefits.

Modifications, additions, or omissions may be made to brokerage system 10 without departing from the scope of the invention. For example, in the illustrated embodiment, service clients 20, service provider 30, and brokerage server 40 are represented as different components of brokerage system 10. However, the functions of service client 20, service provider 30 and brokerage server 40 may be performed by any suitable combination of one or more servers or other components at one or more locations. In the embodiment where the various components are servers, the servers may be public or private servers, and each server may be a virtual or physical server. The server may include one or more servers at the same or at remote locations. Also, service clients 20, service provider 30, and brokerage server 40 may include any suitable component that functions as a server. Additionally, brokerage system 10 may include any number of service clients 20, service providers 30, and/or brokerage server 40. Any suitable logic may perform the functions of brokerage system 10 and the components within brokerage system 10.

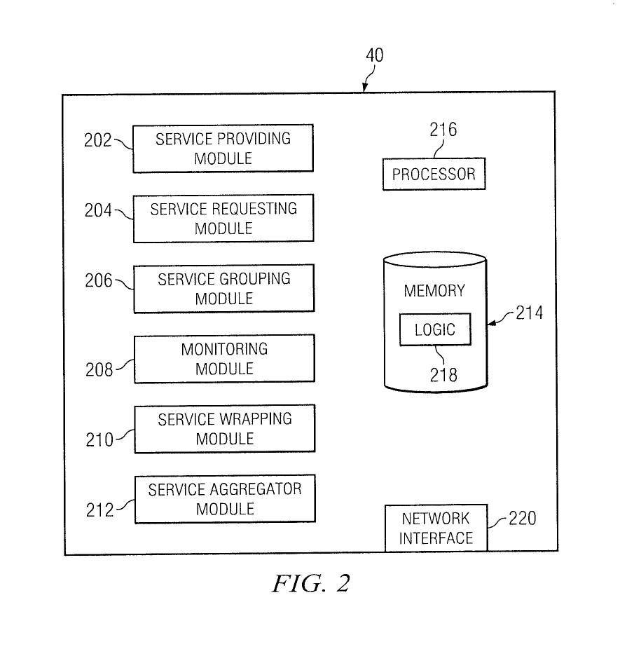

FIG. 2 is a block diagram illustrating aspects of the brokerage server 40 discussed above with respect to FIG. 1. As discussed above, brokerage server 40 facilitates transactions between service clients 20 and service providers 30. Brokerage server 40 receives requests for information technology services from service clients 20 and receives offers for information technology service from service providers 30. Brokerage server includes service providing module 202, service requesting module 204, service grouping module 206, monitoring module 208, service wrapping module 210, service aggregator module 212, memory 214, processor 216, and network interface 220.

Service providing module 202 allows service providers 30 to offer information technology services to service clients 20. In particular embodiments, service providers 30 transmit offer data 64 to service providing module 202 to offer services according to forecasted supply and demand and/or resource availability. Service providing module 202 also allows service providers 30 to offer enhanced service offerings to service clients 20. In service providing module 202, service providers 30 may publish in the interactive environment last minute deals in order to efficiently maximize service capacity. Service providing module 202 enables service providers 30 to predictably or opportunistically offer reduced cost deals to service clients 20. By offering information technology services at a reduced cost for limited times, service providers 30 may provision services that would otherwise go unused. Service providing module 202 may also offer discounted prices for future consumption of requested information technology services, in order to balance “smart grid” utilization, and defer service clients 20 currently utilizing information technology services provided by service provider 30 to a later time period. Thus, service providers 30 may dynamically shift the provisioning of information technology services during peak-demand periods to off-peak-demand periods in order to efficiently manage capacity.

Service requesting module 204 enables a reverse triggering for establishment of the relationship between service providers 30 and service clients 20. Instead of the service clients 20 searching for the best solution and service, the prospect service clients 20 request proposals for information technology service from service providers 30. Service requesting module 204 enables service providers 30 to compete for the requested service. Service requesting module 204 builds requests for proposals (RFP), and transmits the RFP to the prospect service providers 30, including a group of different types of service providers 30, which enables service client 20 to purchase an integrated information technology service solution. In particular embodiments, a service requesting module 204 may facilitate the formation of seller group 35 for price reductions. This enables the service providers 30 to reduce costs by increasing the transaction size, and acting as major facilitators.

Service grouping module 206 facilitates the formation of buyer group 25 comprising service clients 20 that would like to form a time-sharing of volume-purchase discount of an information technology service. In particular embodiments, service grouping module 206 facilitates the formation of buyer group 25 and seller group 35. Buyer group 25 represent one or more service clients 20 that request the same or similar information technology service. In some embodiments, buyer group 25 is able to obtain a discounted price for a volume purchase of information technology service. The discounted price is less than the aggregate of the prices each of the service clients 20 would otherwise be charged separately. In some embodiments, buyer group 25 is able to share an information technology service. For example, service provider 30 may offer access to a processing resource in discrete time intervals of a minimum duration. Service clients 20 may not wish to purchase the minimum duration of the processing resource. Service grouping module 206 may form buyer group 25 to aggregate the amount of time intervals one or more service clients 20 wish to purchase in order to meet the minimum duration threshold.

Monitoring module 208 monitors actual usage of the provisioned information technology service in order to bill the correct amount of consumed services. The monitoring module 208 ensures that a predefined service level agreement is within the requested limits. After an amount of service is consumed, monitoring module 208 calculates an appropriate amount to pay service providers 30 based on the actual quality of the provided service. In case of a service level agreement violation, monitoring module 208 may deduct an amount from any expected future payments and/or refunds to service clients 20 an amount already paid. Thus, fulfillment of the service level agreement violation, and balancing the difference is not required, since it is conducted in real-time.

Service wrapping module 210 aggregates and delegates the request data 62 from multiple service clients 20 to a single service provider 30 of an information technology service. Service wrapping module 210 identifies a plurality of service clients 20 that request the same or similar information technology service. Based on information included in received request, service wrapping module 210 may identify a particular service provider 30 that can provide the information technology service requested. Service wrapping module may communicate with service grouping module 206 to facilitate the formation of buyer group 25.

Service aggregator module 212 aggregates smaller information technology services into a larger solution, and combines multiple services with relevant service level agreements. Service aggregator module 212 may facilitating the formation of an ad-hoc, private cloud for a single service client 20. For example, service aggregator module 212 may use information included in offer data 64 received from a plurality of service providers 30 to group different types of information technology services into a single service offering. As an illustration, service aggregator module 212 receives an offer data 64 that includes an offer for a web hosting service from a particular service provider 30, and an offer of data storing from another particular service provider 30. Service aggregator module 212 may aggregate the two offered services to form seller group 35 and present a combined web hosting and data storage service to service client 20.

Memory 214 comprises any suitable arrangement of random access memory (RAM), read only memory (ROM), magnetic computer disk, CD-ROM, or other magnetic or optical storage media, or any other volatile or non-volatile memory devices that store one or more files, lists, tables, or other arrangements of information. Although FIG. 2 illustrates memory 214 as internal to brokerage server 40, it should be understood that memory 214 may be internal or external to brokerage server 40, depending on particular implementations. Memory 214 may be separate from or integral to other memory devices to achieve any suitable arrangement of memory devices for use in brokerage system 10.

Memory 214 is generally operable to store request data 62, offer data 64, buyer group 25, seller group 35, and any other appropriate information associated with the provisioning of information technology services between service clients 20 and service providers 30. Memory 24 is further operable to store logic 218.

Memory 214 is communicatively coupled to processor 216. Processor 216 is generally operable to execute logic 218 to receive request data 62 from service clients 20 and offer data 64 for information technology service from service providers 30. Processor 216 facilitates transactions between service clients 20 and service providers 30 by determining which offered information technology services included in offer data 64 may fulfill a request for an information technology service included in request data 62. In particular embodiments, processor 216 may execute logic 218 to form buyer group 25 and seller group 35, and to match willing buyers and sellers of information technology services. Processor 216 comprises any suitable combination of hardware and software implemented in one or more modules to provide the described function or operation.

Network interface 220 communicates information relevant to the provision of information technology services between service client 20 and service provider 30 over network 50. For example, network interface 220 receives request data 62 from service client 20 through network 50. Similarly, network interface 220 receives offer data 64 from service provider 30 through network 50. As another example, network interface 220 communicates with service client 20 and service provider 30 to notify service client 20 and service provider 30 of an accepted offer and/or request for information technology services. Network interface 220 represents any port or connection, real or virtual, including any suitable hardware and/or software that allow brokerage server 40 to exchange information with network 50, service client 20, service provider 30, and/or or other components of brokerage system 10.

In general, each of service providing module 202, service requesting module 204, service grouping module 206, monitoring module 208, service wrapping module 210, service aggregator module 212, memory 214, processor 216, logic 218 and network interface 220 represent any appropriate combination of hardware and/or software suitable to perform the described functions. Additionally, any two or more of service providing module 202, service requesting module 204, service grouping module 206, monitoring module 208, service wrapping module 210, and service aggregator module 212 may include common elements.

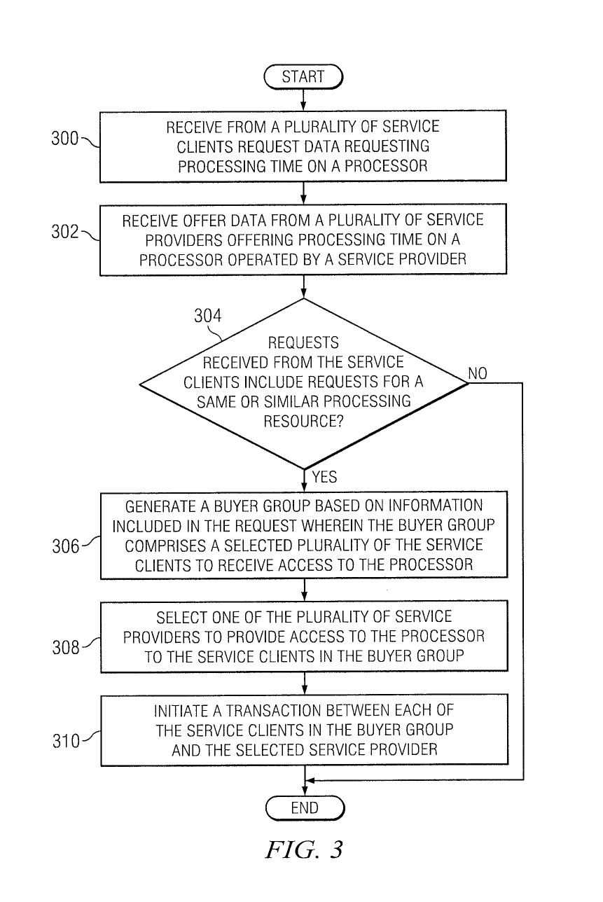

FIG. 3 is a flow diagram illustrating an operation in accordance with a particular embodiment of brokerage system 10. It should be understood that the flow diagram illustrated in FIG. 3 represents one example of an operation that may be performed in a particular embodiment of brokerage system 10. Brokerage system 10 may perform other operations in accordance with particular embodiments as described in the present disclosure.

Operation, in the illustrated example, begins at step 300 with brokerage server 40 receiving, from each of a plurality of service clients, request data 62 which requests processing time on a processor. In particular embodiments, a request for processing time on a processor is a request for an information technology service. For example, a request for processing time on a processor may include requesting data storage, requesting access to software as a service operated by service provider 30, requesting access to internet-based applications hosted by service provider 30, access to computing time on a processor operated by service provider 30, requesting internet website hosting, and/or any other appropriate information technology service associated with the processing, transfer, generating and/or exchange of data. In some embodiments, brokerage server 40 receives a request for an information technology service over network 50.

At step 302 brokerage server 40 receives, from each of a plurality of service providers 30, an offer for access to a processor operated by the respective service provider 30. An offer for access to a processor is an example of an offer for an information technology service. As noted above, an offer for access to a processor may include an offer for data storage, access to software as a service operated by service provider 30, access to internet-based applications hosted by service provider 30, access to computing time on a processor operated by service provider 30, internet website hosting, and/or any other appropriate information technology service associated with the processing, transfer, generating and/or exchange of data. Brokerage server 40 may receive an offer for an information technology service from service provider 30 over network 50.

At step 304, brokerage server 40 determines whether request data 62 received from each of a plurality of service clients 20 include requests for a same or similar processing resource. Brokerage server 40 uses information included in request data 62, such as, for example, the type of processing resource requested, a processing time required, a service level agreement requested by service client 20, a price service client 20 is offering to pay, and a time at which the request expires, to match same or similar requests. For example, all requests from service clients 20 requesting a processing resource that provides for data storage may be grouped. Sub-groups may be formed for all requests from service clients 20 that request data storage of an equal amount. As another example, brokerage server 40 may determine that all requests from service clients 20 requesting processing time as an interne website hosting service are the same or similar. The amount of variance that may exists between the one or more requests that brokerage server 40 considers the same or similar may vary depending on the overall capabilities and requirements of brokerage system 10. If the received requests are the same or similar, operation proceeds at step 306. If not, operation terminates as shown in FIG. 3.

At step 306, brokerage server 40 generates a buyer group based on information included in request data 62, wherein the buyer group comprises a selected plurality of the service clients 20 to receive access to the processor. Based on the determination performed in step 304, brokerage server 40 generates a buyer group comprising service clients 20 that have requested a same or similar processing resource. The formation of a buyer group for obtaining information technology service from service providers 30 facilitates time-sharing of information technology service, group purchases, and/or volume discounts.

At step 308, brokerage server 40 selects one of the plurality of service providers 30 to provide access to the processor to the service clients 20 in the buyer group. Brokerage server 40 selects a particular service provider 30 to provide access to the processor based on any appropriate criteria, factors, or variables. For example, brokerage server 40 may select a particular service provider 30 that is offering the lowest price for the service. Brokerage server 40 may select a particular service provider 30 that is offering the soonest execution time, most favorable service level agreements to service clients 20. Brokerage server 40 may select a particular service provider 30 that is offering a last minute deal, offering to defer access to the processor in exchange for a discount, and/or offering a discount for volume purchases by multiple service clients 20. Moreover, brokerage server 40 may select a server provider 30 based on a predetermined combination of any appropriate criteria, factors, or variables.

At step 310, brokerage server 40 initiates a transaction between each of the service clients 20 in the buyer group and the selected service provider. Brokerage server 40 may initiate a transaction by transmitting a notification to service provider 30 that a buyer group has requested its offered service and by transmitting a notification to each of the service clients 20 in the buyer group that service provider 30 has offered its requested service. In particular embodiments, each of service clients 20 and service provider 30 may transmit to brokerage server 40 an acknowledgement that service client 20 and/or service provider 30 will accept the transaction. The receipt of acknowledgement may finalize the transaction. Brokerage server 40 may accept payment for the requested access to the processing resource from service clients 20, or service clients 20 may pay the relevant service provider 30 directly. In some embodiments, as discussed above, brokerage server 40 monitors the provisioning of the access to the processor of service provider 30 to ensure adequate quality assurance for service client 20 and to adjust a price paid for access to the process in cases of inadequate quality assurance.

The steps illustrated in FIG. 3 may be combined, modified, or deleted where appropriate, and additional steps may also be added to those shown. Additionally, the steps may be performed in any suitable order without departing from the scope of the present disclosure.

Although the present disclosure has been described with several embodiments, numerous changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method comprising:
receiving, from each of a plurality of service clients, a request for processing time on a processor;
receiving, from each of a plurality of service providers, an offer for processing time on a processor associated with each respective service provider;
generating a buyer group based on information included in each respective request, wherein the buyer group comprises a selected one or more of the plurality of service clients to receive processing time a processor associated with a selected one of the plurality of service providers;
selecting one of the plurality of service providers to provide processing time on the processor associated with the selected service provider to the service clients in the buyer group; and
initiating a transaction between each of the service clients in the buyer group and the selected service provider.

2. The method of claim 1, wherein the request identifies an application to execute on one or more of the processors.

3. The method of claim 2, further comprising:
generating a seller group based on information included in each respective offer and the one or more applications identified in the request, wherein the seller group comprises a selected one or more of the plurality of service providers to provide processing time on the processor associated with each respective service provider.

4. The method of claim 1, wherein initiating a transaction comprises selecting a period of time for each of the service clients in the buyer group to obtain processing time on the processor associated with the selected service provider.

5. The method of claim 1, wherein the offer of processing time identifies a price to purchase time on the processor at a time subsequent to the request that is less than a price to purchase time on the processor contemporaneous to the request.

6. The method of claim 1, wherein the offer identifies a time at which the offer expires, and wherein the offer identifies a price to purchase time on the processor that is less than a price to purchase time on the processor after the offer expires.

7. The method of claim 2, further comprising executing the one or more applications on the processor associated with the selected service provider; and
monitoring a quality of service associated with the execution of the one or more applications.

8. A system comprising:
a plurality of service clients each operable to transmit a request for processing time on a processor;
a plurality of service providers each operable to transmit an offer for processing time on a processor associated with each respective service provider; and
a brokerage server operable to:
receive, from each of the plurality of service clients, the request;
receive, from each of the plurality of service providers, the offer;
generate a buyer group based on information included in each respective request, wherein the buyer group comprises a selected one or more of the plurality of service clients to receive processing time on a processor associated with a selected one of the plurality of service providers;
select one of the plurality of service providers to provide processing time on the processor associated with the selected service provider to the service clients in the buyer group; and
initiate a transaction between each of the service clients in the buyer group and the selected service provider.

9. The system of claim 8, wherein the request identifies one or more applications to execute on one or more of the processors.

10. The system of claim 9, wherein the brokerage server is further operable to:
generate a seller group based on information included in each respective offer and the one or more applications identified in the at least one the requests, wherein the seller group comprises a selected one or more of the plurality of service providers to provide processing time on the processor associated with each respective service provider.

11. The system of claim 8, wherein the brokerage server is operable to initiate a transaction by selecting a period of time for each of the service clients in the buyer group to obtain processing time on the processor associated with the selected service provider.

12. The system of claim 8, wherein the offer of processing time identifies a price to purchase time on the processor at a time subsequent to the request that is less than a price to purchase time on the processor contemporaneous to the request.

13. The system of claim 8, wherein the offer identifies a time at which the offer expires, and wherein the offer identifies a price to purchase time on the processor that is less than a price to purchase time on the processor after the offer expires.

14. The system of claim 9, wherein the plurality of service providers are further operable to execute the one or more applications, and wherein the brokerage server is operable to monitor a quality of service associated with the execution of the application.

15. A computer readable storage medium comprising logic, the logic operable, when executed, to:
receive, from each of a plurality of service clients, a request for processing time on a processor;
receive, from each of a plurality of service providers, an offer for processing time on a processor associated with each respective service provider;
generate a buyer group based on information included in each respective request, wherein the buyer group comprises a selected one or more of the plurality of service clients to receive processing time on a processor;
select one of the plurality of service providers to provide processing time on the processor associated with the selected service provider to the service clients in the buyer group; and
initiate a transaction between each of the service clients in the buyer group and the selected service provider.

16. The computer readable storage medium of claim 15, wherein the request identifies one or more applications to execute on one or more of the processors.

17. The computer readable storage medium of claim 16, wherein the logic is further operable to:
generate a seller group based on information included in each respective offer and the one or more applications identified in the request, wherein the seller group comprises a selected one or more of the plurality of service providers to provide processing time on the processor operated by each respective service provider.

18. The computer readable storage medium of claim 15, wherein the logic is operable to initiate a transaction by selecting a period of time for each of the service clients in the buyer group to obtain processing time on the processor associated with the selected service provider.

19. The computer readable storage medium of claim 15, wherein the offer identifies a price to purchase time on the processor at a time subsequent to the request that is less than a price to purchase time on the processor contemporaneous to the request.

20. The computer readable storage medium of claim 15, wherein the offer identifies a time at which the offer expires, and wherein the offer identifies a price to purchase time on the processor that is less than a price to purchase time on the processor after the offer expires.

21. The computer readable storage medium of claim 16, wherein the logic is operable monitor a quality of service associated with the execution of the one or more applications on the processor of the selected service provider.

22. A system comprising:
means for receiving, from each of a plurality of service clients, a request for processing time on a processor;
means for receiving, from each of a plurality of service providers, an offer for processing time on a processor associated with each respective service provider;
means for generating a buyer group based on information included in each respective request, wherein the buyer group comprises a selected one or more of the plurality of service clients to receive processing time on a processor;
means for selecting one of the plurality of service providers to provide processing time on the processor associated with the selected service provider to the service clients in the buyer group; and
means for initiating a transaction between each of the service clients in the buyer group and the selected service provider.
